(19) United States
(12) Patent Application Publication
(10) Pub. No.: US 2014/0216159 A1
(43) Pub. Date: Aug. 7, 2014

(54) METHOD AND ARRANGEMENT FOR DETERMINING AND/OR MONITORING THE STATE OF A ROLLER BEARING

(71) Applicants: Sven Gattermann, Zirndorf (DE); Hans-Henning Klos, Feucht (DE); Klaus-Dieter Müller, Nuremberg (DE); Hans Tischmacher, Lauf (DE)

(72) Inventors: Sven Gattermann, Zirndorf (DE); Hans-Henning Klos, Feucht (DE); Klaus-Dieter Müller, Nuremberg (DE); Hans Tischmacher, Lauf (DE)

(73) Assignee: SIEMENS AKTIENGESELLSCHAFT, Munich (DE)

(21) Appl. No.: 14/346,046

(22) PCT Filed: Sep. 30, 2011
(86) PCT No.: PCT/EP2011/067078

§ 371 Date: Mar. 20, 2014

(51) Int. Cl. G01M 13/04

(52) U.S. Cl. CPC G01M 13/045
USPC 73/593

(57) ABSTRACT

In a method for determining and/or monitoring the state of a roller bearing wherein during the operation of the roller bearing a sensor signal in the form of a sound emission signal is detected in a frequency band in the ultrasonic range, according to an embodiment of the invention shock pulses in the sensor signal are determined. As a result, electrical bearing currents in the roller bearing can be detected and damage to the bearing can therefore be avoided early.

### PRIORITY STATEMENT

This application is the national phase under 35 U.S.C. §371 of PCT International Application No. PCT/EP2011/067078 which has an International filing date of Sep. 30, 2011, which designated the United States of America, the entire contents of each of which are hereby incorporated herein by reference.

### FIELD

At least one embodiment of the invention generally relates to a method and/or an arrangement respectively for determining and/or monitoring the state of a roller bearing. At least one embodiment of the invention further generally relates to a system for determining and/or monitoring the state of a machine comprising at least two such arrangements.

### BACKGROUND

WO 2010/009750 A1 discloses the capture of a sensor signal in the form of a sound emission signal in a frequency band in the ultrasonic range for the purpose of determining and/or monitoring the state of a roller bearing during the operation thereof. In this case, a characteristic value for damage being done or already done to the roller bearing is determined from the signal form of the sensor signal, and the state of the roller bearing is determined by means of comparison with a reference value. In this case, the product of maximal value and effective value of the respective sensor signal is calculated in order to determine the characteristic value.

EP 2 053 375 A and DE 40 17 449 A1 disclose methods for diagnosing roller bearings, wherein pulses are also analyzed in the solid-borne sound range up to approximately 20 kHz in the context of normal vibration monitoring, in order to detect bearing damage.

### SUMMARY

At least one embodiment of the present invention is directed to preventing damage to a roller bearing even earlier. An arrangement which supports such a method is also disclosed. Also, a particularly advantageous system is disclosed for determining and/or monitoring the state of a machine including a plurality of roller bearings.

In respect of at least one embodiment of the method, during operation of the roller bearing, a sensor signal in the form of a sound emission signal is captured in a frequency band in the ultrasonic range, and shock pulses in the sound emission signal are determined.

In at least one embodiment of the invention, an arrangement is disclosed for determining and/or monitoring the state of a roller bearing during the operation thereof, wherein said arrangement comprises a sensor for capturing a sensor signal in the form of a sound emission signal in a frequency band in the ultrasonic range, and a signal processing facility for determining shock pulses in the sensor signal. As a result of determining the shock pulses, it is easy to detect detrimental bearing currents at an early stage and therefore prevent damage to the bearing at an early stage.

A system according to at least one embodiment of the invention for determining and/or monitoring the state of a machine having more than two roller bearings comprises at least two, in particular exactly two, arrangements as described above, wherein the sensors of the arrangements are attached at different positions on or in the machine and the number of arrangements is smaller than the number of roller bearings. By comparing the amplitudes and/or the capture times (or propagation times) of the shock pulses, the location at which the shock pulse is generated and hence the relevant roller bearing can be inferred using relatively few, in particular only two, sensors and an associated signal processing facility. A larger number of bearings in a machine can therefore be monitored for bearing currents using only a few such arrangements, preferably only two.

### BRIEF DESCRIPTION OF THE DRAWINGS

The invention and further advantageous embodiments of the invention according to features in the subclaims are explained below with reference to example embodiments in the figures, in which:

FIG. 1 shows an arrangement according to an embodiment of the invention for determining and/or monitoring the state of a roller bearing, and

FIG. 2 shows a system according to an embodiment of the invention for determining and/or monitoring the state of a machine having more than two roller bearings.

### DETAILED DESCRIPTION OF THE EXAMPLE EMBODIMENTS

In respect of at least one embodiment of the method, during operation of the roller bearing, a sensor signal in the form of a sound emission signal is captured in a frequency band in the ultrasonic range, and shock pulses in the sound emission signal are determined.

At least one embodiment of the invention takes as its starting point the knowledge that electrical currents through the roller bearing, such as those which can occur due to voltage potential differences between the inner and outer rings of the bearing in the case of e.g. converter-supplied electric motors, can result in the ignition of an arc if the breakdown voltage of the lubricating film on the bearing is exceeded. In the case of high breakdown energies, so-called corrugation occurs due to vaporization of material from the track. A structure of peaks and troughs develops in the track in this case, resulting in increased bearing vibration, bearing noise and ultimately premature bearing failure.

However, the occurrence of vaporization is associated with an acoustic shock pulse which can be captured by a sensor in a frequency band in the ultrasonic range. By determining the shock pulses, it is therefore easy to provide for early detection of detrimental bearing currents and therefore early prevention of damage to the bearing. This can be done either during an initial start-up phase in the operation of the roller bearing, or during subsequent live operation.

In this context, sound emission or “acoustic emission” (AE) is understood to mean a phenomenon wherein elastic waves are generated by an intermittent excitation resulting from a sudden release of energy within a solid. Corresponding sound emission signals, which propagate in the form of solid-borne sound in the solid, normally occur in a frequency range of approximately 80 kHz to 1 MHz.

It emerges that shock pulses caused by bearing currents occur primarily in a frequency range of approximately 80 kHz to 150 kHz and are preferably also determined in this frequency range in order to detect the bearing currents.

It likewise emerges that the duration of the shock pulses which are generated by and emanate from the bearing, said shock pulses being caused by bearing currents (subsequently also referred to as “source pulses”), lies in the range of some microseconds to a few milliseconds. Therefore for the purpose of detecting the bearing currents, provision is preferably made for determining shock pulses having a duration in the range of 1 μs to 10 ms. The precise duration depends on the spatial extent of the material transformation or damage. The source pulse is directly proportional to the diameter of the material change and indirectly proportional to the speed of sound in the material. It must however also be taken into consideration in this case that reflection, refraction, dispersion, etc. occur during propagation of a solid-borne sound wave in the material, and change the wave form picked up by the sensor compared with the wave form directly at the source. Moreover, the wave form is changed by the sensor transmission function, wherein resonant solid-borne sound sensors in particular reverberate, i.e. the pulses are prolonged by the natural resonance of the sensor. In the context of a known sensor transmission function, the sensor response and hence the die-away effect of the sensor can be calculated for a jump function. Detected pulses of shorter duration than this die-away effect do not therefore originate from sound emission sources, but rather from electromagnetic interference of the electronics or similar. Such pulses of too short a duration are preferably ignored or filtered out.

According to a further particularly advantageous embodiment, for the purpose of detecting the bearing current, provision is made for determining shock pulses whose pulse rise time is shorter than their pulse fall time. This is based on the finding that the solid-borne sound pulses generated by bearing currents have a relatively short pulse rise time due to the plastic material distortion of the solid, and a comparatively longer pulse fall time due to the elastic dying away of the material particles.

According to an advantageous embodiment of the method, provision is made for counting the shock pulses that are determined. The absolute number of shock pulses can then be used to infer the number of dielectric breakdowns and hence the exposure of the bearing to bearing currents and the degree of damage already sustained in the bearing. In this case, provision is preferably made for determining and counting shock pulses whose amplitude is significantly higher than the sensor noise. A particularly accurate representation of the bearing current pulses can be provided by means of a histogram. Provision is made here for depicting the frequency relative to the (maximal) shock pulse amplitude. A large number of shocks having a high amplitude signifies a high level of damage in this context. In the same way as the pulse amplitude, the pulse duration can also be used as a characteristic feature for the purpose of classifying the material damage. The pulses can also be classified into different amplitude classes by characterizing the pulses on the basis of an average amplitude per time unit (e.g. seconds).

Since at least one embodiment of the method allows the damages to be detected in particular such that they can be identified individually, it is advantageously possible to specify the state of the bearing by adding all the pulses (preferably in a histogram) over the entire service life of the bearing. In a similar manner to the amplitudes, the RMS (root mean square) value of the pulses is also a suitable means of characterizing the pulses in terms of energy content. The RMS value can be used in a similar manner to the (maximal) amplitudes to specify the state of the bearing.

An accurate indication of the bearing exposure to bearing currents can be obtained by determining a number and/or an average amplitude of shock pulses over a defined duration, i.e. a “shock pulse rate” or an “average shock pulse amplitude”, and comparing this with a reference value. The result of this comparison can then be output to e.g. an output device such as e.g. a monitor. It emerges that the reference value is not dependent on the rotational speed in this case, but on the lubrication clearance and the lubrication clearance change in the bearing.

If the number of shock pulses over the defined duration exceeds the reference value, it is also possible to output an alarm signal.

In this case, it is particularly easy to determine bearing currents as the cause of a shock pulse if, in addition to the shock pulses, the bearing currents are also measured by means of a bearing current sensor and the temporal occurrence of sound emission pulses is compared with the temporal occurrence of electromagnetic bearing current pulses. In the event of bearing current damage, both measuring methods return an increased frequency of high-amplitude pulses, which can be displayed and compared e.g. by representation as a histogram in each case.

As per the method described in WO 2010/009750 A1, the same sensor signal can also be used to determine a characteristic value for mechanical damage already done or being done to the roller bearing, e.g. pitting, and a mechanical damage state of the roller bearing can be determined by means of comparison with a reference value which depends on the rotational speed of the roller bearing. By virtue of the combined capture and analysis of the sensor signal, a particularly meaningful specification of the state of the roller bearing is possible. Maintenance activities and times can therefore be scheduled more effectively.

The characteristic value can be specified with particular ease by calculating the product of maximal value and effective value of the respective sensor signal in order to determine the characteristic value.

In at least one embodiment of the invention, an arrangement is disclosed for determining and/or monitoring the state of a roller bearing during the operation thereof, wherein said arrangement comprises a sensor for capturing a sensor signal in the form of a sound emission signal in a frequency band in the ultrasonic range, and a signal processing facility for determining shock pulses in the sensor signal. As a result of determining the shock pulses, it is easy to detect detrimental bearing currents at an early stage and therefore prevent damage to the bearing at an early stage.

The ideas, findings and advantages cited in respect of embodiments of the method according to the invention apply correspondingly to the arrangement according to at least one embodiment of the invention. With regard to the following preferred developments of the arrangement according to at least one embodiment of the invention, the same applies in each case to the corresponding developments of embodiments of the method according to the invention.

The signal processing facility is preferably so designed that shock pulses in a frequency range of 80 kHz to 150 kHz can be determined.

Furthermore, the signal processing facility is preferably so designed that shock pulses having a duration in the range of 1 μs to 10 ms can be determined.

In a further advantageous embodiment, the signal processing facility is so designed that shock pulses whose pulse rise time is shorter than their pulse fall time can be determined.

In an advantageous embodiment, the arrangement has a counter for counting the shock pulses which have been determined.

According to a further advantageous embodiment, the arrangement comprises an analysis device for performing a comparison between a number and/or an average amplitude of the shock pulses over a defined duration and a reference value.

In this case, the analysis device is advantageously so designed as to output an alarm signal if the number of shock pulses and/or the average amplitude over the defined duration exceeds the reference value.

The analysis unit can also be coupled to a condition monitoring system in this case. The determined state of the roller bearing can then be entered into an administrative schedule of maintenance activities and times.

In order to allow reliable yet structurally simple capture of the sound emission signals, the sensor is preferably realized as a piezoelectric, piezoresistive, capacitive or inductive sensor.

Using the same sensor, corresponding to the arrangement described in WO 2010/009750 A1, the arrangement can moreover comprise a further signal processing facility for determining from the first sensor signal a characteristic value in respect of mechanical damage already done or being done to the roller bearing, and also the analysis device for determining the mechanical damage state of the roller bearing by performing a comparison of the characteristic value with a reference value which is dependent on the rotational speed of the roller bearing.

A system according to at least one embodiment of the invention for determining and/or monitoring the state of a machine having more than two roller bearings comprises at least two, in particular exactly two, arrangements as described above, wherein the sensors of the arrangements are attached at different positions on or in the machine and the number of arrangements is smaller than the number of roller bearings. By comparing the amplitudes and/or the capture times (or propagation times) of the shock pulses, the location at which the shock pulse is generated and hence the relevant roller bearing can be inferred using relatively few, in particular only two, sensors and an associated signal processing facility. A larger number of bearings in a machine can therefore be monitored for bearing currents using only a few such arrangements, preferably only two.

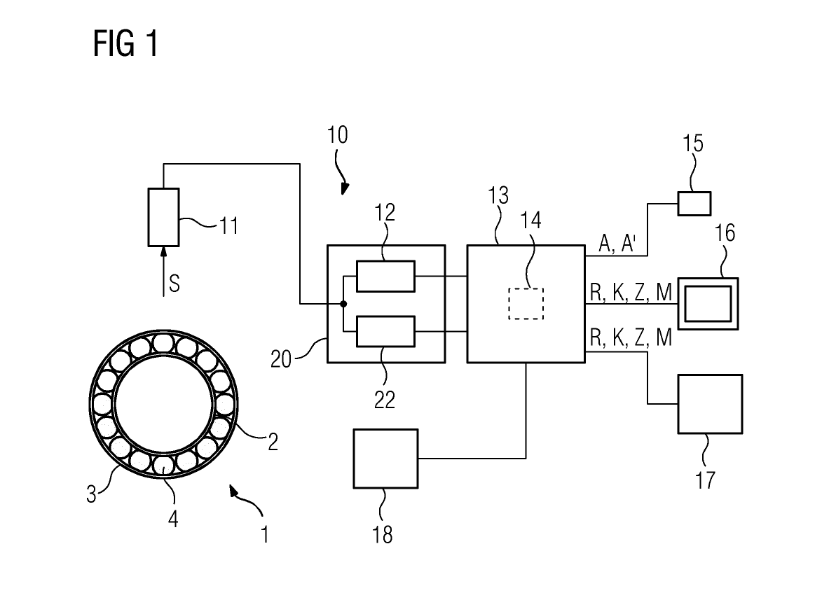

A roller bearing 1 shown in FIG. 1 has an inner ring 2, an outer ring 3, and rolling elements 4 (e.g. balls or rollers) which are arranged between these two rings, this configuration being known to a person skilled in the art.

An arrangement 10 is used to determine and/or monitor the state of the roller bearing 1 during the operation thereof. The arrangement 10 comprises a sensor 11 for capturing a sensor signal S in the form of a sound emission signal in a frequency band in the ultrasonic range and, connected to said sensor 11, a signal processing facility 12 for determining shock pulses in the sensor signal S.

The sensor 11 is preferably realized as a piezoelectric, piezoresistive, capacitive or inductive sensor and can be mounted on either the outer ring 3 or the inner ring 2, integrated in the bearing 1, or even mounted in the vicinity of the bearing by means of a good mechanical coupling.

In order to detect shock pulses that are caused by electrical currents through the bearing 1, the signal processing facility 12 is so designed as to be capable of determining shock pulses which lie in a frequency range of 80 kHz to 150 kHz, have a duration in the range of 1 μs to 10 ms, and a pulse rise time which is shorter than a pulse fall time. In this case, the signal processing facility 12 is embodied in the form of an integrated electrical circuit, for example.

In this case, it is taken into consideration by the signal processing facility 12 that the pulses are prolonged by the natural resonance of the sensor 11. In the context of a known sensor transmission function, the sensor response and hence the die-away effect of the sensor can be calculated for a jump function. Detected pulses of shorter duration than this die-away effect do not therefore originate from sound emission sources, but rather from electromagnetic interference of the electronics or similar. Such pulses of too short a duration are preferably ignored or filtered out by the signal processing facility 12.

The arrangement 10 further comprises an analysis device 13 for determining the maximal amplitude of the shock pulses in each case, the number of shock pulses over a defined duration, i.e. a shock pulse rate, and the average amplitude over the defined duration, i.e. an average shock pulse amplitude.

The analysis device 13 is also used to compare the shock pulse rate and the average shock pulse amplitude with a reference value in each case.

For this purpose, the analysis device 13 comprises one or more counters 14 for counting the shock pulses determined by the signal processing facility 12, preferably separately for different amplitude ranges (i.e. amplitude classes) and pulse duration ranges (i.e. duration classes).

The analysis device 13 is further so designed as to output an alarm signal A if the number of shock pulses or the average shock pulse amplitude exceeds the respective reference value over the defined duration.

For this purpose, the analysis device 13 is connected to an alarm generator 15 (e.g. an optical or acoustic signal generator) via which the alarm signal A can be output.

During the operation of the roller bearing 1, dielectric breakdowns are generated in the bearing 1 by electrical bearing currents, this in turn causing pulsed sound emission signals in the ultrasonic range to be generated in a frequency range of 80 kHz to 150 kHz. A sensor signal S in the form of a sound emission signal containing these shock pulses and lying in the ultrasonic range is captured by the sensor 11.

The shock pulses in the sensor signal S are determined by the signal processing facility 12. The shock pulses determined by the signal processing facility 12 are counted in the counter 14 of the analysis device 13, separately in each case for different amplitude ranges and/or duration ranges if applicable. The result Z of this counting is output to the monitor 16.

The number of shock pulses and an average amplitude of the shock pulses over a defined duration (e.g. per minute), i.e. a shock pulse rate R and an average shock pulse amplitude M, are also determined by the analysis device 13 and likewise output to the monitor 16.

The analysis unit 13 also compares the number of shock pulses determined over the defined duration and the average shock pulse amplitude with a reference value in each case, and outputs an alarm signal A to the alarm generator 15 if the number of shock pulses or the average shock pulse amplitude over the defined duration exceeds the respective reference value.

In a similar manner to the (maximal) amplitudes and durations, the RMS value of the pulses is also a suitable means of characterizing the pulses in terms of energy content. The RMS value can be used in a similar manner or in addition to the (maximal) amplitudes and durations.

A particularly good insight into the state of the bearing 1 can be obtained by means of a histogram. In this context, the frequency of the shock pulses relative to the shock pulse amplitude is displayed on the monitor 16. A large number of shocks having a high amplitude signifies a high level of damage here.

The cause or origin of a pulse can be determined particularly accurately by comparing the temporal occurrence of sound emission pulses with the occurrence of electromagnetic bearing current pulses (measured by a bearing current sensor 18) in the analysis device 13. In the event of bearing current damage, both measuring methods return an increased frequency of high-amplitude pulses, which can be displayed and compared on the monitor 16 by representation as a histogram in each case.

In order also to determine other damage already done or being done to the roller bearing 1 in addition to the bearing currents, the arrangement 10 further comprises a second signal processing facility 22 for determining from the first sensor signal S a characteristic value K for damage already done or being done to the roller bearing 1. The analysis device 13 is also used in this case to determine the damage state of the roller bearing by performing a comparison of this characteristic value K with a reference value which is dependent on the rotational speed of the roller bearing 1.

Both of the signal processing facilities 12 and 22 are combined in a single signal processing device 20 in this case.

The signal processing device 20 and the analysis device 13 can be combined in a single integrated electrical circuit here.

The analysis device 13 can also be used to compare the characteristic value K with at least one second reference value, which is dependent on the material, the size, the mass and/or the type of the roller bearing 1.

In order to determine the characteristic value K, provision is preferably made for calculating the product of maximal value and effective value of the sensor signal S.

In this case, the analysis device 13 outputs an alarm signal A′ to the alarm generator 15 if the characteristic value K deviates over a defined duration from the respective reference value which is dependent on the rotational speed of the roller bearing 1.

The characteristic value K is also output to the monitor 16 by the analysis device 13.

The arrangement 10 is also coupled to a condition monitoring system 17, to which it transfers the total number Z of shock pulses (separately if applicable for different ranges of maximal amplitudes, durations or RMS values of the shock pulses), the shock pulse rates R, the average shock pulse amplitudes M and the characteristic values K.

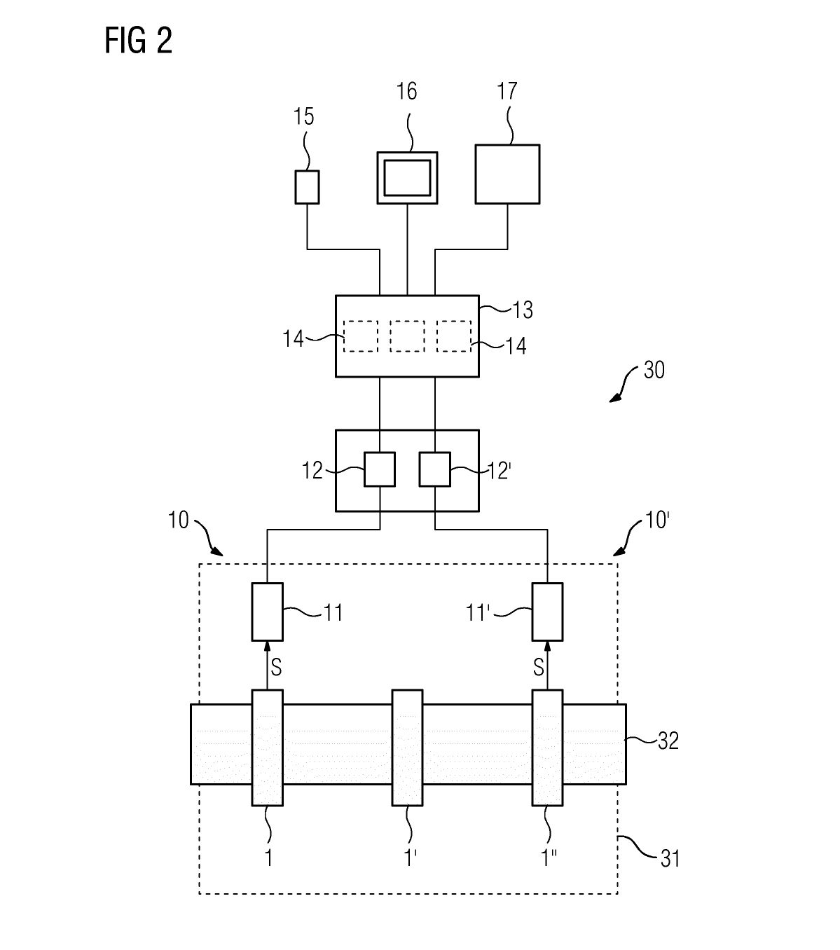

A system 30 as illustrated in FIG. 2 for determining and/or monitoring the state of a machine 31 having a shaft 32 with three roller bearings 1, 1′, 1″ comprises two arrangements 10, 10′ having respectively a sensor 11, 11′ and a signal processing facility 12, 12′ in each case as described in connection with FIG. 1. The sensors 11, 11′ are attached at different positions on or in the machine 31 in this case. The number of arrangements 10, 10′ is smaller than the number of roller bearings 1, 1′, 1″ in this case.

By analyzing the propagation time delays between the captured shock pulses and/or the amplitudes of the shock pulses, it is possible to infer the location at which the shock pulse occurred and hence the roller bearing concerned. Two sensors are therefore sufficient to determine the location at which the shock pulse occurred and to attribute the shock pulses to one of the bearings 1, 1′, 1″.

To this end, the signal processing facilities 12, 12′ can be so designed as to determine the amplitude of the shock pulses, and the analysis device 13 can be so designed as to determine the location at which the shock pulses were generated by comparing the amplitudes of the shock pulses.

Alternatively, the analysis device 13 can be so designed as to determine the location at which the shock pulse was generated by comparing the capture time of the shock pulses.

The analysis device 13 is therefore used to determine the shock pulses or the shock pulse rate and to attribute these shock pulses or the shock pulse rate to one of the bearings 1, 1′, 1″. To this end, for each of the bearings 1, 1′, 1″ respectively, the analysis device 13 comprises a counter 14 for the shock pulses of the bearing 1, 1′, 1″.

As described in relation to FIG. 1, the analysis device is also connected to an alarm generator 15, a monitor 16 and a state monitoring system (condition monitoring system) 17.

1. A method for at least one of determining and monitoring a state of a roller bearing, comprising:
capturing a sensor signal in the form of a sound emission signal in a frequency band in the ultrasonic range, during operation of the roller bearing; and
determining shock pulses in the sensor signal for the purpose of detecting bearing currents.

2. The method of claim 1, wherein shock pulses in a frequency range of 80 kHz to 150 kHz are determined.

3. The method of claim 1, wherein shock pulses including a duration in the range of 1 μs to 10 ms are determined.

4. The method of claim 1, wherein shock pulses whose pulse rise time is shorter than their pulse fall time are determined.

5. The method claim 1, wherein the determined shock pulses are counted.

6. The method claim 1, wherein at least one of a number and an average amplitude of the shock pulses over a defined duration is determined and compared with a reference value.

7. The method of claim 1, wherein a characteristic value for damage already done or being done to the roller bearing is also determined from the sensor signal and a damage state of the roller bearing is determined by performing a comparison with a reference value which is dependent on the rotational speed of the roller bearing.

8. An arrangement for at least one of determining and monitoring the state of a roller bearing during operation, comprising:
a sensor, configured to capture a sensor signal in the form of a sound emission signal in a frequency band in the ultrasonic range; and
a signal processing facility is configured to determine shock pulses in the sensor signal for the purpose of detecting bearing currents.

9. The arrangement of claim 8, wherein the shock pulses are in a frequency range of 80 kHz to 150 kHz.

10. The arrangement of claim 8, wherein the shock pulses includes a duration in the range of 1 μs to 10 ms.

11. The arrangement of claim 8, wherein the shock pulses include a pulse rise time that is relatively shorter than their pulse fall time.

12. The arrangement of claim 8, further comprising:
a counter configured to count the determined shock pulses.

13. The arrangement of claim 8, further comprising:
an analysis device configured to perform a comparison between at least one of a number and an average amplitude of the shock pulses over a defined duration with a reference value.

14. The arrangement of claim 8, wherein the analysis device is coupleable to a condition monitoring system.

15. The arrangement (10) of claim 8, further comprising:
a further signal processing facility configured to determine, from the first sensor signal, a characteristic value for damage already done or being done to the roller bearing, wherein the analysis device is additionally configured to determine the damage state of the roller bearing by performing a comparison of the characteristic value with a reference value which is dependent on the rotational speed of the roller bearing.

16. A system for at least one of determining and monitoring the state of a machine including more than two roller bearings, comprising:
at least two of the arrangements of claim 8, wherein the sensors of the arrangements are attached at different positions on or in the machine and wherein the number of arrangements is smaller than the number of roller bearings.

17. The method claim 6, wherein an alarm signal output if at least one of the number of shock pulses and the average amplitude over the defined duration exceeds the reference value.

18. The method of claim 7, wherein the product of maximal value and effective value of the sensor signal is calculated for the purpose of determining the characteristic value.

19. The arrangement of claim 9, wherein the shock pulses includes a duration in the range of 1 μs to 10 ms.

20. The arrangement of claim 9, wherein the shock pulses include a pulse rise time that is relatively shorter than their pulse fall time.

21. The arrangement of claim 10, wherein the shock pulses include a pulse rise time that is relatively shorter than their pulse fall time.

22. The arrangement of claim 19, wherein the shock pulses include a pulse rise time that is relatively shorter than their pulse fall time.

23. The arrangement of claim 12, further comprising:
an analysis device configured to perform a comparison between at least one of a number and an average amplitude of the shock pulses over a defined duration with a reference value.

24. The arrangement of claim 13, wherein the analysis device is configured to output an alarm signal if the at least one of the number of shock pulses and the average amplitude over the defined duration exceeds the reference value.

25. The arrangement of claim 23, wherein the analysis device is configured to output an alarm signal if the at least one of the number of shock pulses and the average amplitude over the defined duration exceeds the reference value.

26. The arrangement of claim 8, further comprising:
a further signal processing facility configured to determine, from the first sensor signal, a characteristic value for damage already done or being done to the roller bearing.

27. A system for at least one of determining and monitoring the state of a machine including more than two roller bearings, comprising:
two of the arrangements of claim 8, wherein the sensors of the arrangements are attached at different positions on or in the machine and wherein the number of arrangements is smaller than the number of roller bearings.
